(19) United States
(12) Patent Application Publication
(10) Pub. No.: US 2015/0115594 A1
(43) Pub. Date: Apr. 30, 2015

(54) Business Card Golf Tee and Methods

(71) Applicant: Robert C. West, San Antonio, TX (US)

(72) Inventor: Robert C. West, San Antonio, TX (US)

(21) Appl. No.: 14/521,889

(22) Filed: Oct. 23, 2014

Related U.S. Application Data
(60) Provisional application No. 61/895,479, filed on Oct. 25, 2013.

(51) Int. Cl. B42D 15/00; G06F 17/50; A63B 57/00

(52) U.S. Cl. CPC B42D 15/008; A63B 57/0018; G06F 17/50
USPC 283/75; 703/1

(57) ABSTRACT

A golf tee business card and methods of use as both a golf tee and as a business promotional item are disclosed. A rectangular card is scored to create a removable disc and is creased vertically twice such that each crease intersects with the horizontally outermost points of the disc. The card is further scored with two vertical cuts; each vertical cut extends from the vertical center line to a tear point a short distance from the top or bottom edge. The card's information content may include multiple forms of Internet location information. The card may be torn at each tear point, folded along the creases and positioned so that the cuts interlock. The assembled configuration may be stood up on its side to tee up the ball or may be placed with the disc cutout face up to tee up the ball.

### CROSS-REFERENCE TO RELATED APPLICATIONS

This application claims priority to U.S. Provisional Application No. 61/895479, filed Oct. 25, 2013, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to business cards and methods of generating interest and Internet traffic using business cards, and in particular to business cards that may be folded into secondary. Golf tees made out of paper and other lightweight foldable material are known in the prior art for their ability to be easily carried and distributed as a promotional item, and for the ability of paper items to degrade in a relatively short time if left discarded in an outdoor area such as a golf course. Such items generally fold or bend to provide a rise in one of two ways: a first type may provide multiple folds in a first dimension so that the full length of the item in a second dimension provides the rise to a rest point for the golf ball on top of one of the folded edges, and a second type provides a circular hole from which a perforated circular cutout suitable for use as a golf ball marker may be removed, and the edge of the empty hole becomes the rest point for the golf ball at a rise that is less than the full length of the second dimension of the item. The prior art lacks, however, a paper golf tee that provides the user with the option of two levels of rise at which to tee up the golf ball without having to disassemble and re-assemble the tee to achieve a different level. The prior art further does not disclose business methods related to paper golf tee products that aid in maximizing the promotional value such products, and how they relate to marketing and promotion in the modern digital age. The relationship of the paper golf tee to online promotion is of particular importance in light of the fact that paper golf tee products are likely to be wholly or partially destroyed or discarded when used as a tee.

Of the prior art, U.S. Design Pat. No. D651265 to Guerrero title “Paper Golf Tee” discloses a paper golf tee foldable from a rectangular card having perforations and creases as well as a circular cutout region. The cuts and creases of Guerrero, however, are suitable only for teeing the golf ball in the first of two positions described above, namely, the rise being equal to one of the paper item's dimensions. The assembled tee cannot be stably positioned so that the circular cutout region faces upward, and thus the circular cutout region cannot be used as a secondary ball support. Further, Guerrero lacks any interlocking structures—only a flap retainer—to maintain its assembled configuration. Further, Guerrero establishes a triangular structure in contact with the ground and only a single additional line of support outside of the triangular structure, which leads to a likelihood that the tee of Guerrero will be knocked over prematurely.

Further, U.S. Pat. No. 5,503,396 to Veylupek Jr. et al discloses a golf tee business card having a tab and slot system whereby a ball support point is created in the face of the card by the removal of the tab, and wherein the tab inserts and retains itself within one or more slots thereby causing the card to bend to create a rise. By selecting from among the several slots, the user may select the desire degree of rise. However, the Veylupek Jr. tee card suffers from the disadvantage that the degree of rise, once set, cannot be changed except by pulling the tab out of its interlocking slot. This procedure is fiddly and time consuming, and likely to damage the tab and/or the slot by the extra manipulation of the paper, thereby ruining its ability to function as a tee at all. Veylupek Jr. also does not disclose a removable marker disc and does not disclose any business methods related to the marketing use of the business card tee.

### SUMMARY OF THE INVENTION

Accordingly, the invention is directed to a golf tee business card and methods of use as both a golf tee and as a business promotional item. A rectangular card is scored to create a perforated removable central disc and is creased vertically twice such that each crease intersects with the horizontally outermost points of the central disc. The card is further scored with two vertical cuts positioned equidistantly from the horizontal center and distally relative to the creases. Each vertical cut extends from the vertical center line to a tear point a short distance from the top or bottom edge such that one cut extends toward the top and the other cut extends toward the bottom.

The printed indicia of the card may include multiple forms of Internet location information, specifically to websites and social media outlets such that the card's information content may be easily retained by the recipient. Multiple locators are provided so that at least one Internet location or data identifier is likely to survive the use and possible destruction of the card as a golf tee.

The card may be torn at each tear point, folded along the creases and positioned so that the cuts interlock. The assembled configuration may be stood up on its side to tee up the ball in a first position suitable for use with a driver as when starting a par 4 or 5 hole. Alternatively, the assembled configuration may be placed with the disc cutout face up to tee up the ball in a second position suitable for use with a club other than a drive as when starting a par 3 hole.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 shows the front face template of the first exemplary embodiment, displaying the template region 10, no-type region 11, content region 12, cutout edge 13, content region edge 14, perforated disc 15, right crease 16, left crease 17, right cut 18, left cut 19, right tear point 20, left tear point 21, first horizontal guideline 22a, second horizontal guideline 22B, third horizontal guideline 22C, fourth horizontal guideline 22D, fifth horizontal guideline 22E, sixth horizontal guideline 22F, first vertical guideline 23A, second vertical guideline 23B, third vertical guideline 23C, fourth vertical guideline 23D, fifth vertical guideline 23E, sixth vertical guideline 23F, seventh vertical guideline 23G, and eighth vertical guideline 23H.

FIG. 2 shows the rear face template of the first exemplary embodiment, displaying the template region 10, no-type region 11, content region 12, cutout edge 13, content region edge 14, perforated disc 15, right crease 16, left crease 17, right cut 18, left cut 19, right tear point 20, left tear point 21, first horizontal guideline 22a, second horizontal guideline 22B, third horizontal guideline 22C, fourth horizontal guideline 22D, fifth horizontal guideline 22E, sixth horizontal guideline 22F, first vertical guideline 23A, second vertical guideline 23B, third vertical guideline 23C, fourth vertical guideline 23D, fifth vertical guideline 23E, sixth vertical guideline 23F, seventh vertical guideline 23G, and eighth vertical guideline 23H.

FIG. 3 shows one face of an exemplary embodiment of the invention bearing business indicia, displaying the heading 30, Twitter identity 31, Facebook identity 32, 2-dimensional barcode 33, URL 34, and general promotional content 35.

FIG. 4 shows a perspective view of the first exemplary embodiment in its first golf tee configuration, displaying the cutout edge 13, right crease 16, left crease 17, right cut 18, left cut 19, and first ball support region 40.

FIG. 5 shows a perspective view of the first exemplary embodiment in its second golf tee configuration with the perforated disc removed, displaying the cutout edge 13, perforated disc 15, right crease 16, left crease 17, right cut 18, left cut 19, and second ball support region 50.

FIG. 6 shows a perspective view of the first exemplary embodiment in its third golf tee configuration with the perforated disc removed, displaying the right crease 16, left crease 17, and second ball support region 50.

### DETAILED DESCRIPTION OF THE INVENTION

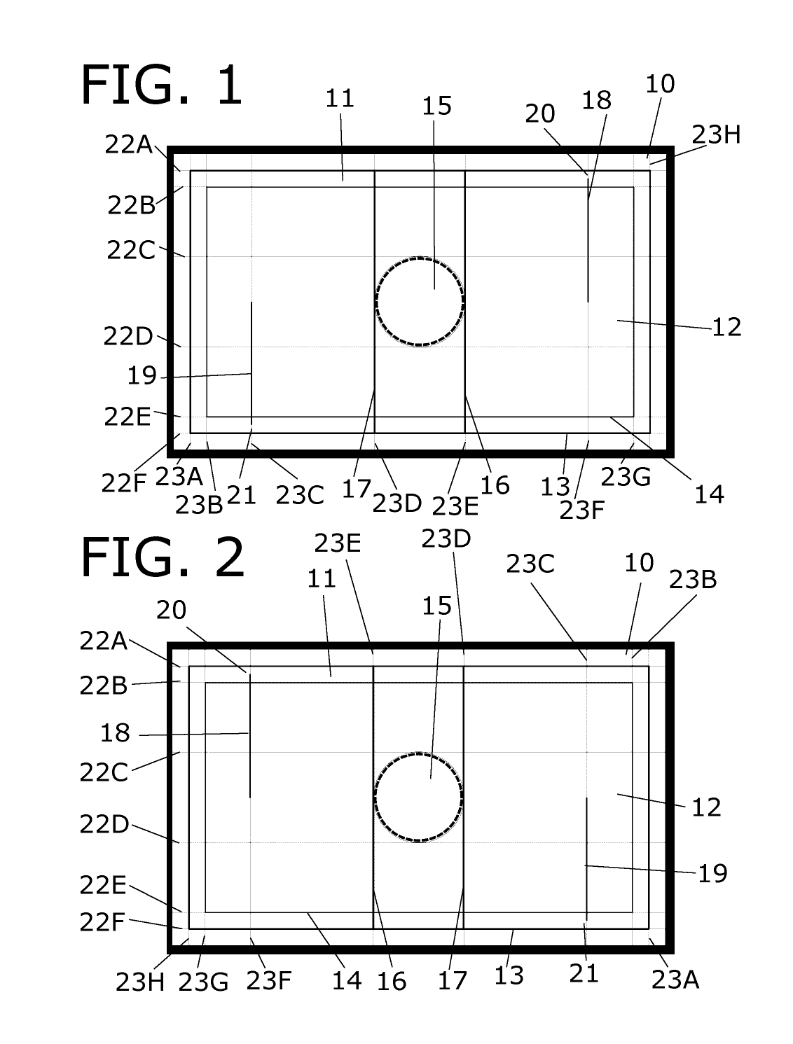

Referring now to the invention in more detail, the invention is directed to a golf tee business card and methods of use as both a golf tee and as a business promotional item. FIGS. 1-2 show a print template for the card; the template region 10 is preferably 3¾ inches by 2¼ inches surrounding a finished card region preferably 3½ inches by 2 inches. The template is presented such that the front is shown in FIG. 1, and the back, with the card flipped horizontally, is shown in FIG. 2. The preferred sizes are intended to match with common practice for business card sizes in the United States, though cards in other customary sizes or non-customary sizes as well as non-rectangular shapes are also contemplated. In addition to a business card embodiment, the invention may be embedded in other types of cards bearing different customary indicia, such as gift cards or certificates, greeting cards, golf scorecards, golf yardage guides or books, and garment tags (for example tags of garments sold in a golf course shop).

The card itself is preferable made of a heavy cardstock material, optionally with an aqueous coating and/or a UV coating, though other durable paper and plastic materials are known in the art of business card printing, and any lightweight and low cost foldable, creaseable, and scoreable sheet material may be used. Materials that will quickly degrade in outdoor conditions, as when the card or fragments thereof are discarded on a golf course, are preferred.

The templates of FIGS. 1-2 show a series of guidelines 22 and 23 indicating the preferred positioning of features on the card. The guidelines are preferably not printed on the card, but may be provided with a digital file template of the card. All measurements of the guidelines 22 and 23 are relative to the front face of the uncut template region 10. Within the template region 10 is the cutout edge 13, and within the cutout edge 13 is the content region edge, all preferably concentric rectangles. The first horizontal guideline 22A is preferably ⅛ inches from the top edge of the template region 10 and defines the top of the cutout edge 13. The second horizontal guideline 22B is preferably ¼ inches from the top edge of the template region 10 and defines the top of the content region edge 14. The third horizontal guideline 22C is preferably 25/32 inches from the top edge of the template region 10 and defines the top extreme point of the perforated disc 15 (the perforated disc being understood, while in digital form, as a region of the template). The fourth horizontal guideline 22D is preferably 25/32 inches from the bottom edge of the template region 10 and defines the bottom extreme point of the perforated disc 15. The fifth horizontal guideline 22E is preferably located ¼ inches from the bottom of the template region 10 and defines the bottom of the content region edge 14. The sixth horizontal guideline 22F is preferably ⅛ inches from the bottom edge of the template region 10 and defines the bottom of the cutout edge 13.

The first vertical guideline 23A is preferably ⅛ inches from the left edge of the template region 10 and defines the left side of the cutout edge 13. The second vertical guideline 23B is preferably ¼ inches from the left edge of the template region 10 and defines the left side of the content region edge 14. The third vertical guideline 23C is preferably positioned 19/32 inches from the left edge of the template region 10 and defines the line of the left cut 19. The fourth vertical guideline 23D is preferably 1 17/32 inches from the left edge of the template region 10 and defines the left extreme point of the perforated disc 15. The fifth horizontal guideline 23E is preferably 1 17/32 inches from the right edge of the template region 10 and defines the right extreme point of the perforated disc 15. The sixth vertical guideline 23F is preferably positioned 19/32 inches from the right edge of the template region 10 and defines the line of the right cut 18. The seventh vertical guideline 23G is preferably ¼ inches from the right edge of the template region 10 and defines the right side of the content region edge 14. The eighth vertical guideline 23H is preferably ⅛ inches from the right edge of the template region 10 and defines the right side of the cutout edge 13.

The template region 10 encompasses the finished card area bounded by guidelines 22A, 23H, 22F, and 23A, which define the cutout edge 13. In its preferred size, the cutout edge 13 leaves a surrounding waste region ⅛ inches wide. The cutout edge 13 surrounds a no-type region 11, which is intended to be a part of the finished card, but is not intended to receive any informational printing, thus allowing for some variance in the precise cutting of the finished card from the template region 10. In its intended size, the no-type region 11 is ⅛ inches wide. The no-type region 11 surrounds the content region 12, with the boundary between the two defined by the content region edge 14. The content region edge 14 is preferably not a printed line on the finished card. The content region edge 14 is defined by guidelines 22B, 23G, 22E, and 23B.

A perforated disc 15 is preferably centered on the card both horizontally and vertically. The perforated disc 15 is scored so that it may be punched out by hand by the user. The perforated disc 15 in its preferred shape and size is circular with a diameter of 11/16 inches. The perforated disc 15 has four cardinal extreme points, each intersecting one of the guidelines 22C, 23E, 22D, and 23D.

A left crease 17 and a right crease 16 are provided in the vertical dimension, thus permitting the card to be easily folded. The left crease 17 aligns with the fourth vertical guideline 23D, and the right crease 16 aligns with the fifth vertical guideline 23E. Both the left crease 17 and the right crease 16 extend over the whole vertical length of the finished card.

A left cut 19 and a right cut 18 are provided. The left cut 19 aligns with the third vertical guideline 23C. The right cut 18 aligns with the sixth vertical guideline 23F. The left cut 19 extends from the vertical center of the card (equivalently, of the template region 10 or of the content region 12) to the left tear point 21, which is preferably located 1/16 inches above the cutout edge 13 on the third vertical guideline 23C. The right cut 18 extends from the vertical center of the card to the right tear point 20, which is preferably located 1/16 inches below the cutout edge 13 on the sixth vertical guideline 23F.

The dimensions shown in the template are intended to be exemplary only, and may vary with the particular application of each embodiment and the particular printing and scoring techniques used.

To use the invention in the game of golf, the user may optionally first remove the perforated disc 15 and use it as a ball marker. The user then prepares a tee by tearing both the left tear point 21 and the right tear point 20, which causes the left cut 19 and the right cut 18 to become slots that extend to the edge of the card in opposing directions. The user then folds the card over the left crease 16 and the right crease 17, and then interlocks the left cut 19 and the right cut 20 as shown in FIG. 4. FIG. 4 shows the card as folded with the front face directed outward, however the user may obtain equivalent results by folding the card inversely with the back face directed outward. The card thus configured may be supported on its bottom or top edge with the opposing edge defining a first ball support region 40. With the perforated disc 15 removed, the card thus configured may be supported on its left and right edges as shown in FIG. 5. The hole left by the removed perforated disc 15 becomes a second ball support region 50.

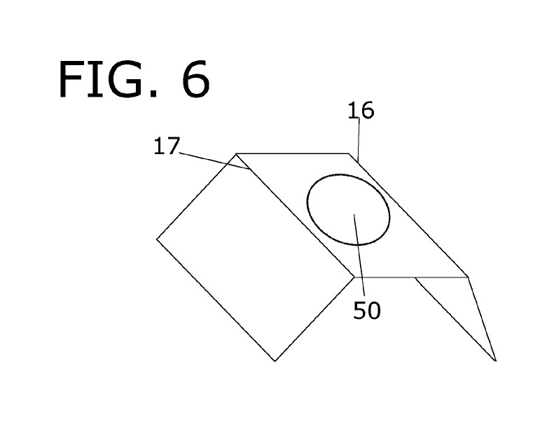

Using the preferred sizes, the first ball support region 40 is higher than the second ball support region 50. The first ball support region 40 is thus preferred when using a driver as on a par 4 or 5 hole, and the second ball support region 50 is thus preferred when using a club other than a driver, as on a par 3 hole. An additional third ball support configuration is shown in FIG. 6, wherein the left cut 19 and right cut are de-interlocked such that the card may stand on its folded leaves with the second ball support region directed vertically upward.

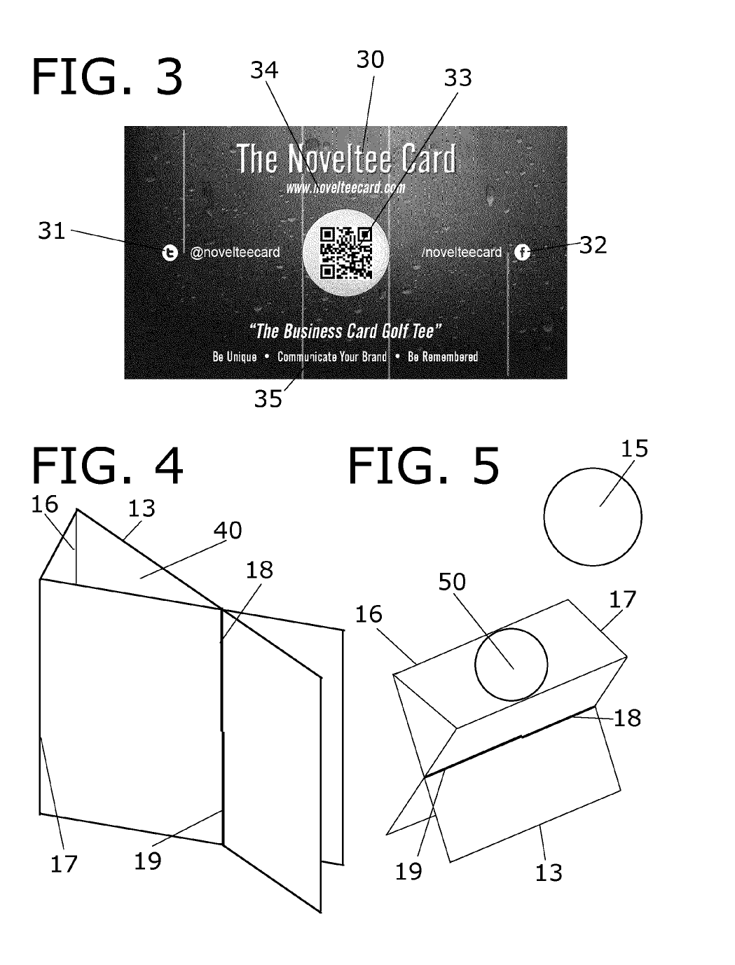

FIG. 3 shows the significant informational content of an exemplary embodiment of the invention. Specifically, the card's informational content preferably includes multiple means of obtaining digital promotional information or locating the card's distributor on the Internet. In addition to a heading 30 and general promotional content 35 (including such traditional information as the business name, address, telephone and fax numbers, etc.), the card provides a Twitter identity 31, Facebook identity 32, a 2-dimensional barcode 33, and a URL 34. The Twitter identity 31 and Facebook identity 32 are exemplary social media identities; other social media systems with their own identifiers may be used to complement the social media presence of the provider of the card. The 2-dimensional barcode 33 preferably contains a digitally encoded URL or social media link, or a VCard or other promotional data. Preferably, at least one data identifier or Internet location is positioned on the separable perforated disc 15, as the 2-dimensional barcode 33 is positioned as shown. The presence of multiple locators and the presence of at least one locator on the perforated disc 15 increases the likelihood that at least some promotional material will survive when the card is actually used in the game of golf.

To use the invention as a promotional tool, the promotional user first selects the marketing message, Internet location information, and other information content of the card and incorporates the information into a graphic design for both the front and back of the card, being mindful to place specially separable information on the perforated disc 15. In addition to an internet locator, the specially separable information may include a graphic logo with which the user may signal an affiliation or affinity while using the perforated disc 15 as a ball marker token. The promotional user then brings copies of the cards to a face-to-face encounter where the promotional user will make new contacts and distributes the cards to the new contacts. In each conversation, the promotional user may bring up the card's features as a golf tee and ball marker, using a verbal description of its use and optional demonstration as an ice-breaker. The conversation will thus improve the chances that the new contact will both form a lasting memory of the promotional user and will follow up by visiting the promotional user's websites or social media outlets. Also increased is the likelihood that the recipient of the card will, when reviewing recently obtained promotional material, recall the explanation and/or demonstration of the card's use in the game of golf and, by extension the promotional user, thus reinforcing the recalled memory.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A digital template for a golf tee business card comprising:
(a) an uncut template region;
(b) a cutout edge, said cutout edge being positioned within said uncut template region;
(c) a first horizontal guideline;
(d) said first horizontal guideline defining the top of said cutout edge;
(e) a content region edge, said content region edge being positioned within said cutout edge;
(f) a no-type region;
(g) said no-type region being between said cutout edge and said content region edge;
(h) a second horizontal guideline;
(i) said second horizontal guideline defining the top of said content region edge;
(j) a content region;
(k) said content region being within said content region edge;
(l) a perforated disc, said perforated disc being positioned within said content region;
(m) a third horizontal guideline;
(n) said third horizontal guideline defining the top extreme point of said perforated disc;
(o) a fourth horizontal guideline;
(p) said fourth horizontal guideline defining the bottom extreme point of said perforated disc;
(q) a fifth horizontal guideline;
(r) said fifth horizontal guideline being defining the bottom of said content region edge;
(s) a sixth horizontal guideline;
(t) said sixth horizontal guideline defining the bottom of said cutout edge;
(u) a first vertical guideline;
(v) said first vertical guideline defining the left side of said cutout edge;
(w) a second vertical guideline;
(x) said second vertical guideline defining the left side of said content region edge;
(y) a third vertical guideline;
(z) a fourth vertical guideline;
(aa) said fourth vertical guideline defining the left extreme point of said perforated disc;
(bb) said third vertical guideline being positioned between said second vertical guideline and said first vertical guideline;
(cc) a fifth vertical guideline;
(dd) said fifth vertical guideline defining the right extreme point of said perforated disc;
(ee) a sixth vertical guideline;
(ff) a seventh vertical guideline;
(gg) said seventh vertical guideline defining the right side of said content region edge;
(hh) said sixth vertical guideline being positioned between said fifth vertical guideline and said seventh vertical guideline;
(ii) an eighth vertical guideline; and
(jj) said eighth vertical guideline defining the right edge of said cutout edge.

2. A golf tee business card generated from the digital template for a golf tee business card of claim 1 comprising:
(a) a left crease;
(b) said left crease corresponding to said fourth vertical guideline and extending the;
(c) a right crease;
(d) said right crease corresponding to said fifth vertical guideline;
(e) a left tear point, said left tear point extending from the bottom edge of said template region to a point in said no-type region, along said third vertical guideline;
(f) a left cut;
(g) said left cut extending from the vertical center of said content area to said left tear point along said third vertical guideline;
(h) a right tear point, said right tear point extending from the top edge of said template region to a point in said no-type region, along said sixth vertical guideline;
(j) a right cut;
(g) said right cut extending from the vertical center of said content area to said right tear point along said right vertical guideline; and
(h) said perforated disc being scored such that said perforated disc may be easily punched out.
